(19) United States
(12) Patent Application Publication
(10) Pub. No.: US 2026/0197846 A1
(43) Pub. Date: Jul. 9, 2026

(54) METHOD AND APPARATUS FOR SIDELINK TRANSMISSION WITH MULTIPLE CANDIDATE STARTING POSITIONS

(71) Applicant: LENOVO (BEIJING) LIMITED, Beijing (CN)

(72) Inventors: Haipeng LEI, Beijing (CN); Xiaodong YU, Beijing (CN); Zhennian SUN, Beijing (CN); Xin GUO, Beijing (CN)

(21) Appl. No.: 19/131,680

(22) PCT Filed: Jan. 19, 2023
(86) PCT No.: PCT/CN2023/073156

§ 371 Date: May 21, 2025

(51) Int. Cl. H04W 72/25; H04L 5/00; H04W 74/0816

(52) U.S. Cl. CPC H04W 72/25; H04L 5/0044; H04W 74/0816

(57) ABSTRACT

Embodiments of the present disclosure relate to methods and apparatuses for a sidelink transmission over an unlicensed spectrum. According to some embodiments of the disclosure, a first UE may: generate a first sidelink transmission comprising a first PSCCH and a first PSSCH, wherein the first PSCCH carries information for scheduling the first PSSCH and the first PSSCH is generated according to a number of available symbols for PSSCH transmission in a first slot with an assumption that the first sidelink transmission is to be started from a predefined candidate starting position of a plurality of candidate starting positions in the first slot; and perform the first sidelink transmission in the first slot from a first candidate starting position of the plurality of candidate starting positions in response to a channel access procedure for initiating a COT from the first candidate starting position in the first slot being successful.

### TECHNICAL FIELD

Embodiments of the present disclosure generally relate to wireless communication technology, and more particularly to multiple candidate starting positions for a sidelink transmission over an unlicensed spectrum.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

A wireless communication system may also support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and/or an unlicensed spectrum.

There is a need for handling sidelink transmissions on an unlicensed spectrum.

### SUMMARY

Some embodiments of the present disclosure provide a first user equipment (UE). The first UE may include a transceiver, and a processor coupled to the transceiver. The processor may be configured to: generate a first sidelink transmission comprising a first physical sidelink control channel (PSCCH) and a first physical sidelink shared channel (PSSCH), wherein the first PSCCH carries information for scheduling the first PSSCH and the first PSSCH is generated according to a number of available symbols for PSSCH transmission in a first slot with an assumption that the first sidelink transmission is to be started from a predefined candidate starting position of a plurality of candidate starting positions in the first slot; and perform the first sidelink transmission in the first slot from a first candidate starting position of the plurality of candidate starting positions in response to a channel access procedure for initiating a channel occupancy time (COT) from the first candidate starting position in the first slot being successful, wherein the first candidate starting position is different from the predefined candidate starting position.

In some embodiments of the present disclosure, the predefined candidate starting position is the last candidate starting position of the plurality of candidate starting positions.

In some embodiments of the present disclosure, receiving the first sidelink transmission in the first slot from the first candidate starting position includes: receiving, from the first UE, the first PSCCH and the first PSSCH from the first candidate starting position in the first slot; and continuously receiving, from the first UE, a second sidelink transmission in the remaining symbols of the first slot.

In some embodiments of the present disclosure, the second sidelink transmission includes the whole or a part of the first PSCCH and the first PSSCH.

In some embodiments of the present disclosure, the second sidelink transmission includes the whole or a part of a third sidelink transmission in the case that the first UE continuously transmits the third sidelink transmission in a second slot following the first slot or the last symbol of the first slot is used for PSSCH transmission.

In some embodiments of the present disclosure, the second sidelink transmission including a second PSCCH and a second PSSCH, and the second PSCCH carries information scheduling the second PSSCH and the second PSSCH is generated based on a number of the remaining symbols of the first slot available for PSSCH transmission.

In some embodiments of the present disclosure, in the case that the first PSSCH and the second PSSCH carry different transport blocks (TBs), the processor is configured to: determine a first physical sidelink feedback channel (PSFCH) resource for a first PSFCH carrying hybrid automatic repeat request acknowledgement (HARQ-ACK) feedback for the first PSSCH and a second PSFCH resource for a second PSFCH carrying HARQ-ACK feedback for the second PSSCH based on indexes corresponding to time domain locations associated with the first PSSCH and the second PSSCH; and transmit, to the first UE, the first PSFCH on the first PSFCH resource and the second PSFCH on the second PSFCH resource.

In some embodiments of the present disclosure, in the case that the COT is initiated by the first UE from the predefined candidate starting position, the processor is configured to receive, from the first UE, the first PSSCH and the first PSCCH from the predefined candidate starting position in the first slot. In the case that the first UE does not contiguously transmit another sidelink transmission in a second slot following the first slot or the last symbol of the first slot is not used for PSSCH transmission, the last symbol of the first PSCCH is punctured.

In some embodiments of the present disclosure, the first PSCCH indicates whether the first UE continuously transmits another sidelink transmission in a second slot following the first slot or not. In some embodiments of the present disclosure, the first PSCCH indicates whether the last symbol of the first slot is used for PSSCH transmission or not.

In some embodiments of the present disclosure, the predefined candidate starting position is the earliest candidate starting position of the plurality of candidate starting positions.

In some embodiments of the present disclosure, receiving the first sidelink transmission in the first slot from the first candidate starting position includes: receiving, from the first UE, the first PSCCH and a part of the first PSSCH from the first candidate starting position in the first slot till a last symbol of the first slot available for PSSCH transmission; and receiving, from the first UE, the remaining part of the first PSSCH in a last slot of the COT or a last slot of a sidelink burst in which the first PSCCH and the first PSSCH are included.

In some embodiments of the present disclosure, the remaining part of the first PSSCH includes at least one demodulation reference signal (DMRS) symbol for decoding the first PSSCH.

In some embodiments of the present disclosure, the first PSCCH indicates a structure of the COT.

Some embodiments of the present disclosure provide a second UE. The second UE may include a transceiver, and a processor coupled to the transceiver. The processor may be configured to: receive, from a first UE, a first sidelink transmission comprising a first PSCCH and a first PSSCH in a first slot, wherein a COT comprising the first sidelink transmission is initiated by the first UE from a first candidate starting position in the first slot, wherein the first PSCCH carries information for scheduling the first PSSCH and the first PSSCH is generated according to a number of available symbols for PSSCH transmission in the first slot with an assumption that the first sidelink transmission is to be started from a predefined candidate starting position of a plurality of candidate starting positions in the first slot, and the first candidate starting position is different from the predefined candidate starting position.

Some embodiments of the present disclosure provide a method performed by a first UE. The method may include: generating a first sidelink transmission comprising a first PSCCH and a first PSSCH, wherein the first PSCCH carries information for scheduling the first PSSCH and the first PSSCH is generated according to a number of available symbols for PSSCH transmission in a first slot with an assumption that the first sidelink transmission is to be started from a predefined candidate starting position of a plurality of candidate starting positions in the first slot; and performing the first sidelink transmission in the first slot from a first candidate starting position of the plurality of candidate starting positions in response to a channel access procedure for initiating a COT from the first candidate starting position in the first slot being successful, wherein the first candidate starting position is different from the predefined candidate starting position.

Some embodiments of the present disclosure provide a method performed by a second UE. The method may include: receiving, from a first UE, a first sidelink transmission comprising a first PSCCH and a first PSSCH in a first slot, wherein a COT comprising the first sidelink transmission is initiated by the first UE from a first candidate starting position in the first slot, wherein the first PSCCH carries information for scheduling the first PSSCH and the first PSSCH is generated according to a number of available symbols for PSSCH transmission in the first slot with an assumption that the first sidelink transmission is to be started from a predefined candidate starting position of a plurality of candidate starting positions in the first slot, and the first candidate starting position is different from the predefined candidate starting position.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2-4 illustrate examples of sidelink transmissions in accordance with some embodiments of the present disclosure;

FIGS. 5 and 6 illustrate flow charts of exemplary procedures of sidelink communications in accordance with some embodiments of the present disclosure; and

FIG. 7 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

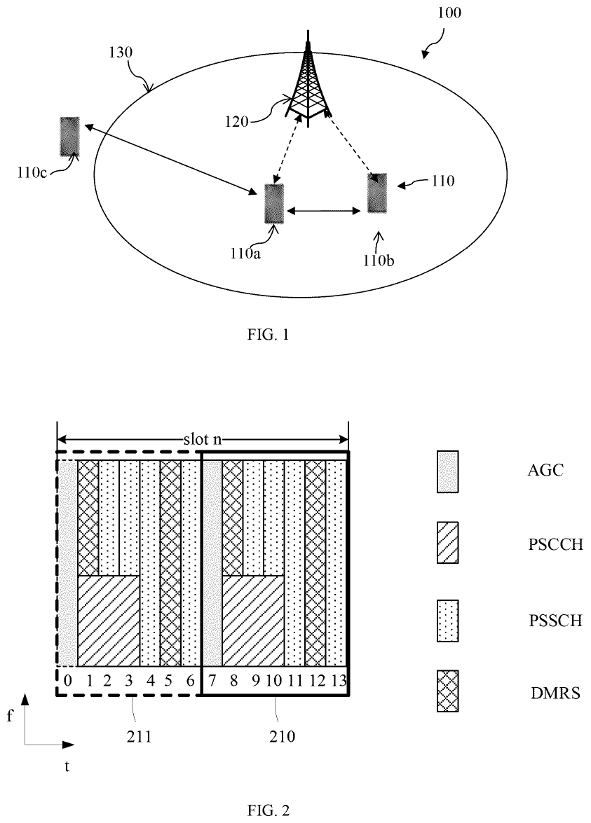

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure. FIG. 1 illustrates a schematic diagram of a wireless communication system 100 in accordance with some embodiments of the present disclosure.

As shown in FIG. 1, wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which is scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

The PSSCH may carry data which may require corresponding HARQ-ACK feedback from the Rx UE(s) to the Tx UE. In some embodiments, broadcast transmission may not need HARQ-ACK feedback. In some embodiments, unicast and groupcast transmission may enable HARQ-ACK feedback under some preconditions. The HARQ-ACK feedback for a PSSCH may be carried on a physical sidelink feedback channel (PSFCH).

In some embodiments of the present disclosure, sidelink transmission may be performed on an unlicensed spectrum. This is advantageous because a sidelink transmission over an unlicensed spectrum can achieve, for example, an increased data rate(s). In order to achieve fair coexistence between various systems, for example, NR systems (e.g., NR-U systems) and other wireless systems, a channel access procedure, also known as a listen-before-talk (LBT) test, may be performed before communicating on the unlicensed spectrum. Only when the LBT test is successful can a UE start transmission on the channel and occupy the channel a certain channel occupancy time (COT), which is less than a maximum channel occupancy time (MCOT). Otherwise, the UE cannot start the transmission and may continue to perform another LBT test until a successful LBT test result.

Due to unpredictability of an LBT test, a Tx UE cannot know when the channel is available for sidelink transmission. If a Tx UE prepares a sidelink transmission (e.g., a PSCCH and a PSSCH scheduled by the PSCCH (which is hereinafter referred to an associated PSSCH)) from a specific starting position (e.g., symbol 0), then when the Tx UE performs a successful LBT and obtains the channel after the specific starting position (e.g., after symbol 0 such as symbol 2) of a slot, the Tx UE may not transmit the prepared sidelink transmission. The Tx UE may wait or transmit some reservation signal and may transmit the prepared sidelink transmission from the specific starting position (e.g., symbol 0) of the next slot. In the worst case, a maximum of 13 symbols of the initial slot is wasted.

Moreover, when a Tx UE is assigned a slot inside of a COT initiated by a BS or another UE, for example, assuming that the assigned resource is started from symbol 0 of the slot, then the Tx UE shall prepare a sidelink transmission (e.g., a PSCCH and an associated PSSCH) from symbol 0. However, when the Tx UE fails in an LBT test before symbol 0 of the slot, the Tx UE cannot transmit the prepared sidelink transmission in the slot. As a result, the Tx UE loses the transmission opportunity and has to wait for the next resource assignment.

A solution to solve the above issue is to prepare multiple sidelink transmissions (e.g., PSCCHs and associated PSSCHs) corresponding to multiple candidate starting positions in a slot. For example, it is assumed that the multiple candidate starting positions may include symbol 0, symbol 4 and symbol 7. Before performing any LBT test, a Tx UE may prepare multiple sidelink transmissions corresponding to the multiple candidate starting positions in a slot, including for example, a first sidelink transmission (e.g., a first PSCCH and an associated first PSSCH) starting from symbol 0, a second sidelink transmission (e.g., a second PSCCH and an associated second PSSCH) starting from symbol 4, and a third sidelink transmission (e.g., a third PSCCH and an associated third PSSCH) starting from symbol 7. The Tx UE can select one of the prepared sidelink transmissions according to the outcome of the LBT test. For example, the Tx UE may select a sidelink transmission from the multiple prepared sidelink transmissions which is prepared with a candidate starting position aligned with the current candidate starting position with a successful LBT test or nearest to the next candidate starting position, and transmit the selected sidelink transmission from the current candidate starting position or the next nearest candidate starting position. For example, assuming that an LBT test is successful at symbol 3, then the UE may transmit the second sidelink transmission from symbol 4.

However, a drawback of the above solution is that the implementation complexity for the Tx UE is too high. In addition, from an Rx UE's perspective, it has to blind detect a sidelink transmission from the first candidate starting position in a slot until the last candidate starting position. In that sense, the implementation complexity for the Rx UE is also high.

Embodiments of the present disclosure provide solutions to solve the above issues. For example, to avoid high implementation complexity at a Tx UE on preparing multiple sidelink transmissions (e.g., PSCCHs and associated PSSCHs) for adapting multiple candidate starting positions (e.g., symbols) within one slot, embodiments of the present disclosure propose preparing a single sidelink transmission. To achieve this, various issues need to be further addressed. For example, since different candidate starting positions lead to different numbers of symbols for a sidelink transmission, how to generate the single sidelink transmission for adapting all the candidate starting positions within one slot should be addressed.

For instance, for a 14-symbol sidelink transmission (e.g., a PSCCH and an associated PSSCH) prepared from symbol 0, when an LBT test fails in symbol 0 and successful in symbol 4, the prepared 14-symbol sidelink transmission cannot be transmitted from symbol 4 due to it is longer than the number of available symbols (e.g., a maximum of 10 symbols) in the slot. Alternatively, even if the prepared 14-symbol sidelink transmission is transmitted from symbol 4, the last 4 symbols of the transmission may have to be punctured, which results in a failed decoding of the PSSCH. For instance, for a 10-symbol sidelink transmission (e.g., a PSCCH and an associated PSSCH) prepared from symbol 4, when an LBT test fails in symbol 4 and successful in symbol 7, the 10-symbol sidelink transmission cannot be transmitted from symbol 7. Alternatively, even if the 10-symbol sidelink transmission is transmitted from symbol 7, the last 3 symbols may have to be punctured, which results in a failed decoding of the PSSCH.

In some embodiments of the present disclosure, a sidelink transmission (e.g., a PSCCH and an associated PSSCH) is prepared based on the last candidate starting position among the multiple candidate starting positions. For example, assuming that the multiple candidate starting positions include symbol 0, symbol 4 and symbol 7, a 7-symbol sidelink transmission (e.g., a PSCCH and an associated PSSCH) may be prepared from symbol 7. When a LBT test is successful in symbol 0, the 7-symbol sidelink transmission can be directly transmitted from symbol 0 and then the last 7 symbols of the slot are left empty. This would not only reduce spectrum utilization efficiency but also increase the risk of losing the channel. Embodiments of the present disclosure further provide enhanced solution to solve the above problems.

By adopting the proposed solutions in the present disclosure, spectrum utilization efficiency can be increased with simple UE implementation. More details on the embodiments of the present disclosure will be illustrated in the following text in combination with the appended drawings.

For simplicity, it is assumed that a slot includes 14 symbols indexed from symbol 0 to symbol 13 in the context of the present disclosure. It should be appreciated by persons skilled in the art that embodiments of the present disclosure can still be applied when other slot configurations are adopted.

In some embodiments of the present disclosure, when a UE (e.g., a Tx UE) intends to initiate a COT for sidelink transmissions over an unlicensed spectrum, to simplify the implementation complexity, only a single sidelink transmission (e.g., a PSCCH and an associated PSSCH) is generated by the Tx UE for transmission. The single sidelink transmission is generated according to the number of available symbols in an initial slot of the COT with an assumption that the single sidelink transmission is to be started from a predefined candidate starting position of a plurality of candidate starting positions in the slot.

In some embodiments of the present disclosure, in the case of multiple candidate starting positions (e.g., symbols) configured or predefined for sidelink transmission within a slot, one design principle is that the last candidate starting position within a slot cannot be later than symbol 7. For example, the multiple candidate starting symbols within a slot can include {0, 3}, {0, 4}, {0, 7}, {0, 3, 7}, or {0, 4, 7}.

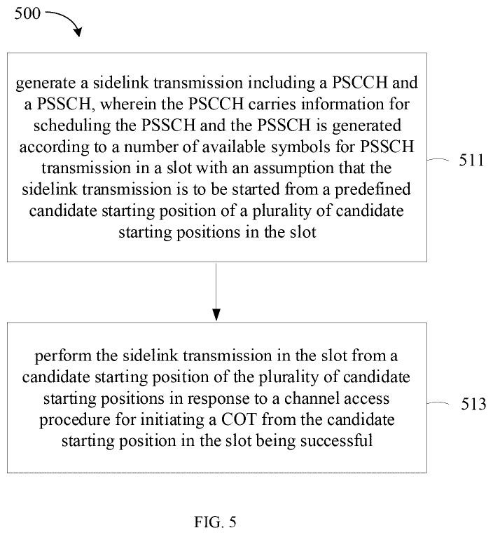

FIG. 5 illustrates a flow chart of exemplary procedure 500 for sidelink communications in accordance with some embodiments of the present disclosure. Details described in all of the foregoing embodiments of the present disclosure are applicable for the embodiments shown in FIG. 5. In some examples, the procedure may be performed by a UE, for example, UE 110 in FIG. 1.

Referring to FIG. 5, in operation 511, a UE (e.g., a Tx UE, and hereinafter denoted as “first UE” for clarity) may generate a sidelink transmission (denoted as “sidelink transmission #1” for clarity) including a PSCCH and a PSSCH (denoted as “PSCCH #1” and “PSSCH #1” respectively for clarity), wherein PSCCH #1 carries information (e.g., sidelink control information (SCI)) for scheduling PSSCH #1 and PSSCH #1 is generated according to a number of available symbols for PSSCH transmission in a slot (denoted as “slot #1” for clarity) with an assumption that sidelink transmission #1 is to be started from a predefined candidate starting position of a plurality of candidate starting positions in slot #1. The plurality of candidate starting positions can include 2, 3, or more candidate starting positions.

In operation 513, the first UE may perform sidelink transmission #1 in slot #1 from a candidate starting position (denoted as “candidate starting position #1” for clarity) of the plurality of candidate starting positions in response to a channel access procedure for initiating a COT from candidate starting position #1 in slot #1 being successful. In some embodiments of the present disclosure, candidate starting position #1 may be the same or different from the predefined candidate starting position.

In some embodiments of the present disclosure, the predefined candidate starting position is the last candidate starting position (e.g., the one with the greatest symbol index) of the plurality of candidate starting positions.

In some embodiments of the present disclosure, performing sidelink transmission #1 in slot #1 from candidate starting position #1 includes: transmitting PSCCH #1 and PSSCH #1 from candidate starting position #1 in slot #1; and continuously performing another sidelink transmission (denoted as “sidelink transmission #2” for clarity) in the remaining symbols of slot #1.

For example, assuming that the supported multiple candidate starting positions are {symbol 0, symbol 7}, then sidelink transmission #1 may be prepared based on symbol 7. In the case that the channel access procedure for initiating a COT from symbol 0 in slot #1 is successful, a UE may transmit the prepared transmission from symbol 0 in slot #1. The UE may continuously perform sidelink transmission #2 in the remaining symbols (e.g., symbols 7 to 13) of slot #1.

Various methods can be employed to determine sidelink transmission #2.

For example, in some embodiments of the present disclosure, sidelink transmission #2 includes the whole or a part of PSCCH #1 and PSSCH #1. For example, depending on the number of the remaining symbols of slot #1 available for PSSCH transmission and the number of symbols of sidelink transmission #1, sidelink transmission #2 may include the whole or a part of PSCCH #1 and PSSCH #1.

In some embodiments of the present disclosure, in the case that the first UE continuously transmits a sidelink transmission (denoted as “sidelink transmission #3” for clarity) in a slot following slot #1 or the last symbol of slot #1 is used for PSSCH transmission, sidelink transmission #2 includes the whole or a part of sidelink transmission #3. For example, depending on the number of symbol of the remaining symbols of slot #1 and the number of symbols of sidelink transmission #3, sidelink transmission #2 may include the whole or a part of sidelink transmission #3.

In some embodiments of the present disclosure, sidelink transmission #2 includes another PSCCH and another PSSCH (denoted as “PSCCH #2” and “PSSCH #2” respectively for clarity). PSCCH #2 carries information (e.g., an SCI) scheduling PSSCH #2 and PSSCH #2 is generated based on a number of the remaining symbols of slot #1 available for PSSCH transmission. For example, sidelink transmission #2 can be used to transmit any available TB in the buffer of the first UE.

In some embodiments of the present disclosure, the same TB is carried on PSSCH #1 and PSSCH #2. Therefore, one HARQ-ACK feedback (e.g., a single HARQ-ACK information bit) for the TB (e.g., for both PSSCH #1 and PSSCH #2) is sufficient. The HARQ-ACK feedback may be generated by the Rx UE based on the decoding results of sidelink transmission #1 and sidelink transmission #2. The first UE may receive one HARQ-ACK feedback for sidelink transmission #1 and sidelink transmission #2.

In some embodiments of the present disclosure, the TB carried on PSSCH #2 may be different from that carried on PSSCH #1. Respective HARQ-ACK feedback for the two TBs (e.g., for PSSCH #1 and PSSCH #2) may be required. Various methods may be employed to determine respective PSFCH resources for the PSFCHs carrying the HARQ-ACK feedback for the two TBs.

For example, in some embodiments of the present disclosure, the first UE (as well as the Rx UE) may determine a PSFCH resource (denoted as “PSFCH resource #1”) for a PSFCH (denoted as “PSFCH #1”) carrying HARQ-ACK feedback for PSSCH #1 and another PSFCH resource (denoted as “PSFCH resource #2”) for another PSFCH (denoted as “PSFCH #2”) carrying HARQ-ACK feedback for PSSCH #2 based on indexes corresponding to time domain locations associated with PSSCH #1 and PSSCH #2. The Rx UE may transmit PSFCH #1 on PSFCH resource #1 and PSFCH #2 on PSFCH resource #2. The first UE may receive PSFCH #1 on PSFCH resource #1 and PSFCH #2 on PSFCH resource #2.

For example, as PSSCH #1 and PSSCH #2 are transmitted in the same slot in different symbol locations, these different symbol locations may correspond to different indexes, which should be considered when determine the PSFCH resources associated with the two PSSCHs in the same slot. Examples for PSFCH resource determination will be described later in the present disclosure.

In some embodiments of the present disclosure, the channel access procedure for initiating the COT from the predefined candidate starting position in slot #1 may be successful. That is, candidate starting position #1 is the predefined candidate starting position. The first UE may transmit PSSCH #1 and PSCCH #1 from the predefined candidate starting position in slot #1. In some embodiments, in the case that the first UE does not contiguously transmit another sidelink transmission in a slot following slot #1 or the last symbol of slot #1 is not used for PSSCH transmission, the last symbol of PSSCH #1 is punctured.

In some embodiments of the present disclosure, PSCCH #1 (e.g., the SCI) may indicate whether the first UE continuously transmits another sidelink transmission in a slot following slot #1 or not. In some embodiments of the present disclosure, PSCCH #1 (e.g., the SCI) may indicate whether the last symbol of slot #1 is used for PSSCH transmission or not.

In this way, the first UE can dynamically indicate whether contiguous transmissions are to be performed in an initial slot and a subsequent slot of the COT. At Rx UE side, it can know how to performing the decoding. For example, the Rx UE can know whether the last symbol of the initial slot is used for PSSCH transmission and determine whether to decode the last symbol in the initial slot.

The following are some examples for sidelink transmissions when the predefined candidate starting position is the last candidate starting position in accordance with the above embodiments of the present disclosure.

For example, it is assumed that the supported multiple candidate starting positions are {symbol 0, symbol 7}. Half-slot based sidelink transmission may be used in the initial slot of a COT and full slot based sidelink transmission may be used in the remaining slots of the COT.

For example, a UE may generate or prepare a single sidelink transmission (e.g., a PSCCH and an associated PSSCH) with 7 consecutive symbols (i.e., assuming that it is to be started from the last candidate starting position, symbol 7). The PSCCH may occupy 2 or 3 symbols at the beginning of the sidelink transmission.

In some examples, the LBT test may fail at symbol 0 and succeed at symbol 7 within the initial slot (e.g., slot n) of the COT. Then, the prepared sidelink transmission (e.g., a PSCCH and an associated PSSCH) is transmitted in the second half of slot n starting from symbol 7. For example, the first symbol of the prepared PSCCH and PSSCH (e.g., including automatic gain control (AGC)) can be mapped to symbol 7 of slot n and onwards.

In some examples, the Tx UE may intend to contiguously transmit a PSSCH in the next slot (e.g., slot n+1) or the last symbol (e.g., symbol 13) of the current slot (e.g., slot n) can be used for PSSCH transmission. Then, the prepared 7-symbol sidelink transmission is transmitted directly in the second half of slot n. For example, the prepared sidelink transmission may be transmitted in region 210 in FIG. 2.

In some examples, the Tx UE may not intend to transmit a PSSCH in the next slot (e.g., slot n+1) or the last symbol (e.g., symbol 13) of the current slot (e.g., slot n) cannot be used for PSSCH transmission. For example, symbol 13 cannot be used for PSSCH transmission when symbol 13 is left for performing a LBT test for the transmission in the next slot, is left for cyclic prefix (CP) extension of the transmission in the next slot, or is left empty as a gap symbol. Then, the prepared 7-symbol sidelink transmission is transmitted in the second half of slot n from symbol 7 to symbol 12. The last symbol of the prepared 7-symbol PSSCH is punctured.

In other examples, a UE may generate or prepare a single sidelink transmission (e.g., a PSCCH and an associated PSSCH) with 6 consecutive symbols. When the Tx UE intends to transmit the sidelink transmission (e.g., the PSSCH) from symbol 7 (e.g., the LBT test succeeds at symbol 7 within the initial slot of the COT), in the case that the last symbol of the initial slot can't be used for PSSCH transmission, then the prepared PSSCH can be directly transmitted from symbol 7 to symbol 12 of the initial slot. In the case that the last symbol of the initial slot can be used for PSSCH transmission, then the prepared PSSCH can be directly transmitted from symbol 7 to symbol 12 of the initial slot, with one-symbol repetition on symbol 13 or with cyclic prefix extension of symbol 0 in the next slot on symbol 13 (i.e., for the purpose of occupying symbol 13 of the initial slot). When the Tx UE intends to transmit the sidelink transmission (e.g., the PSSCH) from symbol 0 (e.g., the LBT test succeeds at symbol 0 within the initial slot of the COT), then the prepared PSSCH can be directly transmitted from symbol 0 to symbol 5 with symbol repetitions in the remaining available symbols in the initial slot.

In some examples, the LBT test may succeed at symbol 0 within the initial slot (e.g., slot n) of the COT. The prepared sidelink transmission is transmitted in the first half of slot n starting from symbol 0. For example, the first symbol of the prepared PSCCH and PSSCH (e.g., including automatic gain control (AGC)) can be mapped to symbol 0 of slot n and onwards. For example, the prepared sidelink transmission may be transmitted in region 211 in FIG. 2.

Various methods can be employed to utilize the second half of slot n.

In some embodiments, the prepared sidelink transmission is repeatedly transmitted from symbol 7 in the second half slot of slot n. In this way, the reliability of a sidelink transmission in the initial slot of a COT can be improved and the channel is fully utilized.

In some embodiments, considering the status of the last symbol of slot n, there are two manners for the Tx UE to repeatedly transmit the prepared 7-symbol sidelink transmission in the second half of slot n.

For example, the Tx UE may intend to contiguously transmit a PSSCH in the next slot (e.g., slot n+1) or the last symbol (e.g., symbol 13) of the current slot (e.g., slot n) can be used for PSSCH transmission. Then, the prepared 7-symbol sidelink transmission is repeatedly transmitted in the second half of slot n. For example, the prepared sidelink transmission may be transmitted in regions 210 and 211 in FIG. 2.

For example, the Tx UE may not intend to transmit a PSSCH in the next slot (e.g., slot n+1) or the last symbol (e.g., symbol 13) of the current slot (e.g., slot n) cannot be used for PSSCH transmission. Then, the prepared 7-symbol sidelink transmission is transmitted in the second half of slot n from symbol 7 to symbol 12, and the last symbol of the prepared 7-symbol PSSCH is punctured.

In some embodiments, when the Tx UE intends to contiguously transmit a PSSCH in the next slot (e.g., slot n+1) or the last symbol (e.g., symbol 13) of the current slot (e.g., slot n) can be used for PSSCH transmission. Then, the first 7 symbols of the sidelink transmission prepared for the next slot is repeatedly transmitted from symbol 7 in the second half of slot n. For example, the first 7 symbols of the sidelink transmission prepared for slot n+1 (not show in FIG. 2) may be transmitted in region 210 in FIG. 2. In this way, the reliability of a sidelink transmission in the second slot of a COT can be improved and the channel is fully utilized.

In some embodiments, a new sidelink transmission is generated for the second half slot of slot n and is contiguously transmitted following the sidelink transmission transmitted in the first half of slot n. For example, the new sidelink transmission can be used to transmit any available TB in the buffer of the Tx UE.

In some examples, when the Tx UE intends to contiguously transmit a PSSCH in the next slot (e.g., slot n+1) or the last symbol (e.g., symbol 13) of the current slot (e.g., slot n) can be used for PSSCH transmission, the new sidelink transmission is generated with 7 symbols. For example, the prepared 7-symbol sidelink transmission for the initial slot and the new sidelink transmission can be respectively transmitted in region 211 and region 210 in FIG. 2.

In some examples, when the Tx UE does not intend to transmit a PSSCH in the next slot (e.g., slot n+1) or the last symbol (e.g., symbol 13) of the current slot (e.g., slot n) cannot be used for PSSCH transmission, the new sidelink transmission is generated with 6 symbols. For example, the new sidelink transmission can be transmitted in the second half of slot n from symbol 7 to symbol 12.

In some embodiments, the same TB is carried on PSSCHs in the first half and the second half of the initial slot of the COT. One HARQ-ACK feedback (e.g., a single HARQ-ACK information bit) for the TB is sufficient. The HARQ-ACK feedback may be generated by the Rx UE based on the decoding results of the two sidelink transmissions in the first half and the second half of the initial slot of the COT. The first UE may receive one HARQ-ACK feedback for the two sidelink transmissions.

In some embodiments, different TBs are carried on PSSCHs in the first half and the second half of the initial slot of the COT. Respective HARQ-ACK feedback for the two TBs may be required. Various methods may be employed to determine respective PSFCH resources for the two PSFCHs carrying respective HARQ-ACK feedback for the two TBs, so as to avoid potential PSFCH resource collision. For example, the PSFCH resources can be determined based on the time domain locations associated with the two TBs.

For example, as different TBs may be carried on different PSSCHs starting from different symbols in the initial slot of a COT, these different starting symbols (e.g., multiple candidate starting positions) can be indexed, for example, indexed as time domain location indexes (or half-slot indexes in some cases, or sub-slot indexes) “0” to “1” in the case that the supported multiple candidate starting positions are {symbol 0, symbol 7}. For a given PSSCH, the corresponding time domain location index can be used for determining the corresponding PSFCH resource for transmitting HARQ-ACK feedback for the PSSCH (e.g., determining the index of the corresponding PSFCH resource).

For example, when the supported multiple candidate starting positions are {symbol 0, symbol 7}, the half-slot index (i.e., the time domain location index) of a PSSCH is used for calculating the corresponding PSFCH resource index.

For example, a UE can determine an index of a PSFCH resource for a PSFCH transmission corresponding to a PSSCH as:

$$( {P}_{ID} + {M}_{ID} + i ) mod {R}_{PRB , CS}^{PSFCH} .$$

In the above formula, i refers to the time domain location index. For example, i=0 for a PSSCH transmission in the first half slot or a PSSCH transmission occupying the two half-slots of one slot (i.e., starting from symbol 0); and i=1 for PSSCH transmission in the second half slot (i.e., starting from symbol 7). P_{ID} refers to a physical layer source ID associated with the PSSCH. For example, P_{ID} may be a physical layer source ID of a Tx UE transmitting the PSSCH and can be indicated in the SCI scheduling the PSSCH. MID refers to the identity of the UE receiving the PSSCH in a UE group in the case that groupcast ACK or NACK based HARQ-ACK feedback is enabled (e.g., a value of a cast type indicator field of the SCI is “01”); or otherwise, MID is zero. The identity of the UE receiving the PSSCH in a UE group may be indicated by higher layers.

$${R}_{PRB , CS}^{PSFCH}$$

refers to a total number of PSFCH resources available for multiplexing HARQ-ACK information in a PSFCH transmission.

In some embodiments, an SCI carried on a PSCCH for scheduling a PSSCH in a slot includes an indicator indicating whether a Tx UE contiguously transmits another sidelink transmission (e.g., a PSCCH and an associated PSSCH) in the next slot or not, or indicating whether the last symbol of the slot is used for PSSCH transmission or not.

In some examples, the above indicator can include one bit. For example, bit value “1” indicates that the Tx UE will contiguously transmit another sidelink transmission in the next slot (e.g., without gap between the two slots) or the last symbol of the current slot is used for transmitting PSSCH, bit value “0” indicates that the Tx UE will not contiguously transmit another sidelink transmission in the next slot or the last symbol of the current slot is not used for transmitting PSSCH; or vice versa.

Although the Tx UE cannot predict from which symbol the prepared sidelink transmission can be transmitted, it is aware of whether a contiguous transmission is to be performed in the two slots. In this way, the Tx UE can dynamically indicate whether contiguous transmissions are to be performed in an initial slot and a subsequent slot of the COT via the indicator in the SCI. At Rx UE side, it can know whether the last symbol of the initial slot is used for PSSCH transmission and determine whether to decode the last symbol in the initial slot of the COT.

For example, it is assumed that the supported multiple candidate starting positions are {symbol 0, symbol 4}. The UE may generate or prepare a single sidelink transmission (e.g., a PSCCH and an associated PSSCH) with 10 consecutive symbols (i.e., assuming that it is to be started from the last candidate starting position, symbol 4). The PSCCH may occupy 2 or 3 symbols at the beginning of the sidelink transmission.

In other examples, a UE may generate or prepare a single sidelink transmission (e.g., a PSCCH and an associated PSSCH) with 9 consecutive symbols. When the Tx UE intends to transmit the sidelink transmission (e.g., the PSSCH) from symbol 4 (e.g., the LBT test succeeds at symbol 4 within the initial slot of the COT), in the case that the last symbol of the initial slot can't be used for PSSCH transmission, then the prepared PSSCH can be directly transmitted from symbol 4 to symbol 12 of the initial slot without a puncturing operation on symbol 13. In the case that the last symbol of the initial slot can be used for PSSCH transmission, then the prepared PSSCH can be directly transmitted from symbol 4 to symbol 12 of the initial slot, with one-symbol repetition on symbol 13 or with cyclic prefix extension of symbol 0 in the next slot on symbol 13 (i.e., for the purpose of occupying symbol 13 of the initial slot). When the Tx UE intends to transmit the sidelink transmission (e.g., the PSSCH) from symbol 0 (e.g., the LBT test succeeds at symbol 0 within the initial slot of the COT), then the prepared PSSCH can be directly transmitted from symbol 0 to symbol 8 with symbol repetitions in the remaining available symbols in the initial slot.

In some examples, the LBT test may fail at symbol 0 and succeed at symbol 4 within the initial slot (e.g., slot n) of the COT. Then, the prepared sidelink transmission (e.g., a PSCCH and an associated PSSCH) is transmitted in slot n starting from symbol 4. For example, the first symbol of the prepared PSCCH and PSSCH (e.g., including automatic gain control (AGC)) can be mapped to symbol 4 of slot n and onwards.

In some examples, the Tx UE may intend to contiguously transmit a PSSCH in the next slot (e.g., slot n+1) or the last symbol (e.g., symbol 13) of the current slot (e.g., slot n) can be used for PSSCH transmission. Then, the prepared 10-symbol sidelink transmission is transmitted directly in slot n from symbol 4.

In some examples, the Tx UE may not intend to transmit a PSSCH in the next slot (e.g., slot n+1) or the last symbol (e.g., symbol 13) of the current slot (e.g., slot n) cannot be used for PSSCH transmission. For example, symbol 13 cannot be used for PSSCH transmission when symbol 13 is left for performing a LBT test for the transmission in the next slot, is left for CP extension of the transmission in the next slot, or is left empty as a gap symbol. Then, the prepared 10-symbol sidelink transmission is transmitted in slot n from symbol 4 to symbol 12. The last symbol of the prepared 10-symbol PSSCH is punctured.

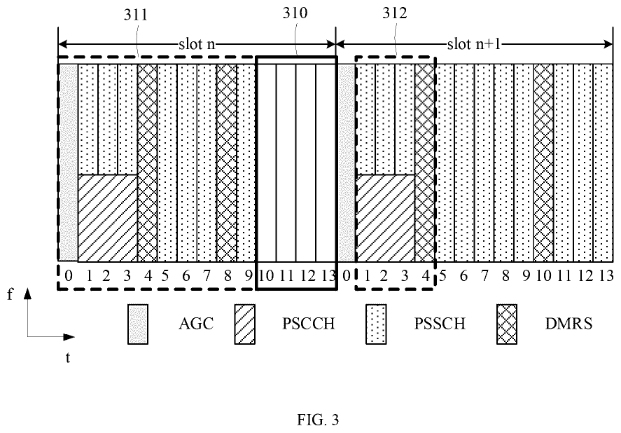

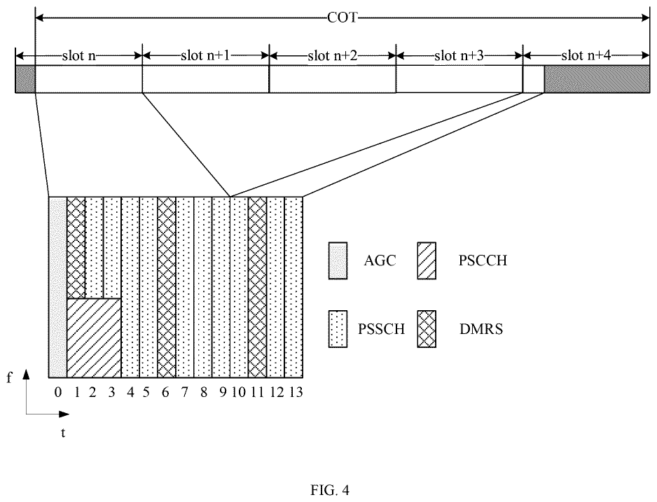

In some examples, the LBT test may succeed at symbol 0 within the initial slot (e.g., slot n) of the COT. The prepared sidelink transmission is transmitted in slot n starting from symbol 0. For example, the first symbol of the prepared PSCCH and PSSCH (e.g., including automatic gain control (AGC)) can be mapped to symbol 0 of slot n and onwards. For example, the prepared sidelink transmission may be transmitted in region 311 in FIG. 3.

Various methods can be employed to utilize the remaining symbols in region 310 of slot n as shown in FIG. 3.

In some embodiments, the prepared sidelink transmission is repeatedly transmitted from symbol 10 in slot n. In this way, the reliability of a sidelink transmission in the initial slot of a COT can be improved and the channel is fully utilized.

For example, the last 3 or 4 symbols of the prepared sidelink transmission are repeatedly transmitted from symbol 10 in slot n, depending on whether the Tx UE will contiguously transmit another sidelink transmission in the next slot (e.g., slot n+1) or not, or depending on whether the last symbol (e.g., symbol 13) of the current slot (e.g., slot n) can be used for PSSCH transmission or not.

For example, the Tx UE may intend to contiguously transmit a PSSCH in the next slot (e.g., slot n+1) or the last symbol (e.g., symbol 13) of the current slot (e.g., slot n) can be used for PSSCH transmission. Then, the last 4 symbols of the prepared 10-symbol sidelink transmission are repeatedly transmitted from symbol 10 to symbol 13 in slot n.

For example, the Tx UE may not intend to transmit a PSSCH in the next slot (e.g., slot n+1) or the last symbol (e.g., symbol 13) of the current slot (e.g., slot n) cannot be used for PSSCH transmission. Then, the last 3 symbols of the prepared 10-symbol sidelink transmission are repeatedly transmitted from symbol 10 to symbol 12 in slot n. Symbol 13 in slot n can be left for performing a LBT test for the transmission in the next slot, or left for CP extension of the transmission in the next slot, or left empty as a gap symbol.

For example, the first 3 or 4 symbols of the prepared sidelink transmission (e.g., excluding the AGC symbol) are repeatedly transmitted from symbol 10 in slot n, depending on whether the Tx UE will contiguously transmit another sidelink transmission in the next slot (e.g., slot n+1) or not, or depending on whether the last symbol (e.g., symbol 13) of the current slot (e.g., slot n) can be used for PSSCH transmission or not.

For example, the Tx UE may intend to contiguously transmit a PSSCH in the next slot (e.g., slot n+1) or the last symbol (e.g., symbol 13) of the current slot (e.g., slot n) can be used for PSSCH transmission. Then, the first 4 symbols of the prepared 10-symbol sidelink transmission (e.g., excluding the AGC symbol) are repeatedly transmitted from symbol 10 to symbol 13 in slot n.

For example, the Tx UE may not intend to transmit a PSSCH in the next slot (e.g., slot n+1) or the last symbol (e.g., symbol 13) of the current slot (e.g., slot n) cannot be used for PSSCH transmission. Then, the first 3 symbols of the prepared 10-symbol sidelink transmission (e.g., excluding the AGC symbol) are repeatedly transmitted from symbol 10 to symbol 12 in slot n. Symbol 13 in slot n can be left for performing a LBT test for the transmission in the next slot, or left for CP extension of the transmission in the next slot, or left empty as a gap symbol.

In some embodiments, when the Tx UE intends to contiguously transmit a PSSCH in the next slot (e.g., slot n+1) or the last symbol (e.g., symbol 13) of the current slot (e.g., slot n) can be used for PSSCH transmission. The first 4 symbols of the sidelink transmission prepared for the next slot is repeatedly transmitted from symbol 10 in slot n. For example, referring to FIG. 3, the first 4 symbols of the sidelink transmission prepared for slot n+1 excluding the AGC symbol in region 312 in FIG. 3 can be repeatedly transmitted in region 310 in FIG. 3. In this way, the reliability of a sidelink transmission in the second slot of a COT can be improved and the channel is fully utilized.

In some embodiments, a new sidelink transmission is generated for contiguously transmitting in slot n following the prepared 10-symbol sidelink transmission. For example, the new sidelink transmission can be used to transmit any available TB in the buffer of the Tx UE.

In some examples, the new sidelink transmission may be generated with 3 or 4 symbols, depending on whether the Tx UE will contiguously transmit another sidelink transmission in the next slot (e.g., slot n+1) or not, or depending on whether the last symbol (e.g., symbol 13) of the current slot (e.g., slot n) can be used for PSSCH transmission or not. For example, the prepared 10-symbol sidelink transmission and the new sidelink transmission can be respectively transmitted in region 311 and region 310 in FIG. 3.

In some embodiments, the same TB is carried on the two PSSCHs transmitted in the initial slot of the COT. One HARQ-ACK feedback (e.g., a single HARQ-ACK information bit) for the TB is sufficient. The HARQ-ACK feedback may be generated by the Rx UE based on the decoding results of the two sidelink transmissions in the initial slot of the COT. The first UE may receive one HARQ-ACK feedback for the two sidelink transmissions.

In some embodiments, different TBs are carried on the two PSSCHs in the initial slot of the COT. Respective HARQ-ACK feedback for the two TBs may be required. Various methods may be employed to determine respective PSFCH resources for the two PSFCHs carrying respective HARQ-ACK feedback for the two TBs, so as to avoid potential PSFCH resource. For example, the PSFCH resources can be determined based on the time domain locations associated with the two TBs. The aforementioned methods for PSFCH resource determination may apply here.

For example, as different TBs may be carried on different PSSCHs starting from different symbols in the initial slot of a COT, these different starting symbols (e.g., multiple candidate starting positions) can be indexed, for example, indexed as time domain location indexes “0” to “1” in the case that the supported multiple candidate starting positions are {symbol 0, symbol 4}. For a given PSSCH, the corresponding time domain location index can be used for determining the corresponding PSFCH resource for transmitting HARQ-ACK feedback for the PSSCH (e.g., determining the index of the corresponding PSFCH resource).

In some embodiments, an SCI carried on a PSCCH for scheduling a PSSCH in a slot includes an indicator indicating whether a Tx UE contiguously transmits another sidelink transmission (e.g., a PSCCH and an associated PSSCH) in the next slot or not, or indicating whether the last symbol of the slot is used for PSSCH transmission or not.

In some examples, the above indicator can include one bit. For example, bit value “1” indicates that the Tx UE will contiguously transmit another sidelink transmission in the next slot (e.g., without gap between the two slots) or the last symbol of the current slot is used for transmitting PSSCH, bit value “0” indicates that the Tx UE will not contiguously transmit another sidelink transmission in the next slot or the last symbol of the current slot is not used for transmitting PSSCH; or vice versa.

Although the Tx UE cannot predict from which symbol the prepared sidelink transmission can be transmitted, it is aware of whether a contiguous transmission is to be performed in the two slots. In this way, the Tx UE can dynamically indicate whether contiguous transmissions are to be performed in an initial slot and a subsequent slot of the COT via the indicator in the SCI. At Rx UE side, it can determine whether to decode the last symbol in the initial slot of the COT.

When the supported multiple candidate starting positions includes other starting positions (e.g., symbols) or more than two starting positions (e.g., symbols), the above embodiments can be similarly applied.

Referring back to FIG. 5, in some embodiments of the present disclosure, the predefined candidate starting position is the earliest candidate starting position (e.g., the one with the smallest symbol index) of the plurality of candidate starting positions.

In some embodiments of the present disclosure, the channel access procedure for initiating the COT from the predefined candidate starting position in slot #1 may be successful. That is, candidate starting position #1 is the predefined candidate starting position. The first UE may directly transmit PSSCH #1 and PSCCH #1 from the predefined candidate starting position (e.g., the earliest candidate starting position) in slot #1 to the last available symbol in slot #1. For example, the first symbol of PSSCH #1 and PSCCH #1 (e.g., including AGC) can be mapped to the earliest candidate starting position of slot #1 and onwards.

In some embodiments of the present disclosure, performing sidelink transmission #1 in slot #1 from candidate starting position #1 includes: transmitting PSCCH #1 and a part of PSSCH #1 from candidate starting position #1 in slot #1 till a last symbol of slot #1 available for PSSCH transmission; and transmitting the remaining part of PSSCH #1 in a last slot of the COT or a last slot of a sidelink burst in which PSCCH #1 and PSSCH #1 are included.

For example, the channel access procedure for initiating the COT may fail for the earliest candidate starting position and succeed for a later candidate starting position (e.g., candidate starting position #1) of the plurality of candidate starting positions in slot #1. Sidelink transmission #1 may be transmitted from candidate starting position #1 to the last available symbol within slot #1 with the first symbol of sidelink transmission #1 including AGC mapped to candidate starting position #1 in slot #1 and onwards. The remaining part of sidelink transmission #1 is suspended and to be transmitted from symbol 0 of the last slot of the COT. Alternative, the remaining part of sidelink transmission #1 is suspended and to be transmitted from symbol 0 of the last slot of a sidelink burst in which sidelink transmission #1 are included.

For example, assuming that the supported multiple candidate starting positions are {symbol 0, symbol 4}, then sidelink transmission #1 may be prepared based on symbol 0 with 14 symbols. In the case that the channel access procedure for initiating a COT from symbol 4 in slot #1 is successful, a UE may transmit a part of sidelink transmission #1 (e.g., PSCCH #1 and a part of PSSCH #1) from symbol 4 to symbol 13 in slot #1. The UE may transmit the remaining 4 symbols of sidelink transmission #1 (e.g., the remaining part of PSSCH #1) in the last slot of the COT. Alternative, the UE may transmit the remaining 4 symbols in the last slot of a sidelink burst in which PSCCH #1 and PSSCH #1 are included.

In some embodiments of the present disclosure, the remaining part of PSSCH #1 includes at least one DMRS symbol for decoding PSSCH #1.

In some embodiments of the present disclosure, PSCCH #1 (e.g., the SCI) indicates the structure of the COT. For example, the COT structure information in PSCCH #1 (e.g., the SCI) may indicate the end of the sidelink burst or the end of the COT.

The idea of transmitting the remaining part of PSSCH #1 in the last slot of the COT or sidelink burst makes sense because the MCOT is in the unit of milliseconds which correspond to integer number of slots. The drawback of this idea is that the decoding of the sidelink transmission #1 (i.e., PSCCH #1 and PSSCH #1) may be delayed. However, this is acceptable because each sidelink TB can be transmitted multiple times (e.g., up to 32 times).

According to this idea, as described above, the Tx UE side may prepare a single sidelink transmission (e.g., a PSCCH and an associated PSSCH) with the assumption that the sidelink transmission is transmitted from the first (earliest) candidate starting position to the last available symbol of the initial slot of the COT. If a LBT test is successful for the first (earliest) candidate starting position, the prepared sidelink transmission is directly transmitted from the first (earliest) candidate starting position to the last available symbol within the initial slot. If the LBT test fails for the first (earliest) candidate starting position and successful for another candidate starting position, the prepared sidelink transmission is transmitted from the another candidate starting symbol to the last available symbol within the initial slot. The remaining part of the prepared sidelink transmission is suspended and to be transmitted from symbol 0 of the last slot of the sidelink burst or the COT. For example, COT structure information indicating the end of the sidelink burst or the end of the COT is included in the PSCCH (e.g., the SCI).

At the Rx UE side, it may blind detect a PSCCH. In the case that the Rx UE detects the PSCCH from the first (earliest) candidate starting symbol, it would know that the prepared sidelink transmission (e.g., the PSSCH scheduled by the PSCCH) is entirely transmitted in the initial slot of the COT. Otherwise, the Rx UE would know that the prepared sidelink transmission (e.g., the PSSCH scheduled by the PSCCH) is partially transmitted in the initial slot and the remaining part is suspended and to be transmitted from symbol 0 of the last slot of the COT or the sidelink burst.

FIG. 4 illustrates an example of sidelink transmissions in accordance with some embodiments of the present disclosure. In the example of FIG. 4, the predefined candidate starting position is the earliest candidate starting position.

Referring to FIG. 4, a UE (e.g., Tx UE) may initiate a COT from slot n to slot n+4 (for example, with a MCOT equal to 4 ms and subcarrier spacing equal to 15 kHz). It is assumed that the supported multiple candidate starting positions are {symbol 0, symbol 4}.

The Tx UE may prepare a sidelink transmission (e.g., a PSCCH and an associated PSSCH) with a duration of 14 symbols. In the case that the LBT test is successful at symbol 0 of slot n (e.g., no dash areas in slot n and slot n+4), the prepared sidelink transmission is directly transmitted from symbol 0 to the last available symbol (e.g., symbol 13) within slot n.

In the case that the LBT test fails at symbol 0 and successful at symbol 4 of slot n, the prepared sidelink transmission is transmitted from symbol 4 to the last available symbol (e.g., symbol 13) in slot n with the first symbol of the prepared sidelink transmission including AGC mapping to symbol 4 of slot n, and the remaining part of the prepared sidelink transmission (i.e., the last 4 symbols of the prepared sidelink transmission) is suspended and to be transmitted from symbol 0 to symbol 3 of the last slot (e.g., slot n+4) of the sidelink burst or the COT.

When the supported multiple candidate starting positions includes other starting positions (e.g., {symbol 0, symbol 7}) or more than two starting positions (e.g., symbols), the above embodiments can be similarly applied.

It should be appreciated by persons skilled in the art that the sequence of the operations in exemplary procedure 500 may be changed and some of the operations in exemplary procedure 500 may be eliminated or modified, without departing from the spirit and scope of the disclosure.

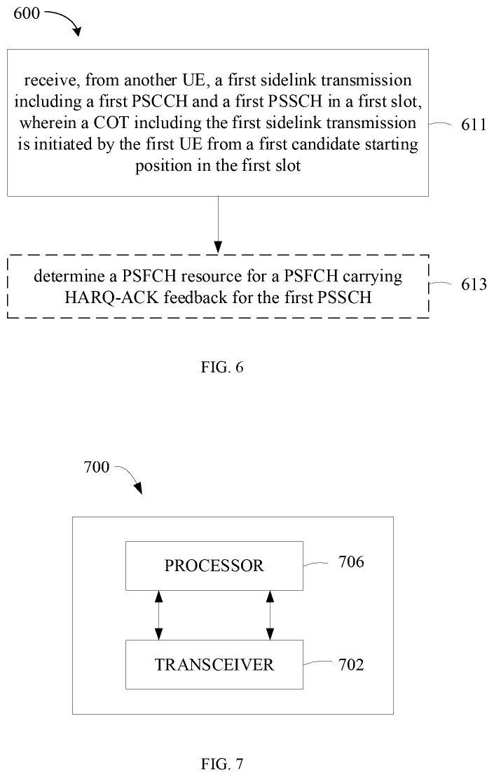

FIG. 6 illustrates a flow chart of exemplary procedure 600 for sidelink communications in accordance with some embodiments of the present disclosure. Details described in all of the foregoing embodiments of the present disclosure are applicable for the embodiments shown in FIG. 6. In some examples, the procedure may be performed by a UE, for example, UE 110 in FIG. 1.

Referring to FIG. 6, in operation 611, a UE (e.g., an Rx UE, and hereinafter denoted as “second UE” for clarity) may receive, from another UE (e.g., a Tx UE, and hereinafter denoted as “first UE” for clarity), a first sidelink transmission including a first PSCCH and a first PSSCH in a first slot, wherein a COT including the first sidelink transmission is initiated by the first UE from a first candidate starting position in the first slot.

The first PSCCH carries information for scheduling the first PSSCH and the first PSSCH is generated according to a number of available symbols for PSSCH transmission in the first slot with an assumption that the first sidelink transmission is to be started from a predefined candidate starting position of a plurality of candidate starting positions in the first slot. In some embodiments of the present disclosure, the first candidate starting position may be different from the predefined candidate starting position.

In some embodiments, the first sidelink transmission, first PSCCH, first PSSCH, first candidate starting position, first slot may be sidelink transmission #1, PSCCH #1, PSSCH #1, candidate starting position #1, slot #1 as described above. The descriptions regarding the predefined candidate starting position in all of the foregoing embodiments may apply here.

In some embodiments of the present disclosure, when, for example, HARQ-ACK feedback for the first PSSCH is enabled, the second UE may determine a PSFCH resource for a PSFCH carrying HARQ-ACK feedback for the first PSSCH in operation 613 (denoted in dotted block as an option). The aforementioned methods for PSFCH resource determination may apply here. The second UE may transmit the HARQ-ACK feedback for the first PSSCH in the determined PSFCH resource to the first UE.

In some embodiments of the present disclosure, the predefined candidate starting position is the last candidate starting position of the plurality of candidate starting positions.

In some embodiments of the present disclosure, receiving the first sidelink transmission in the first slot from the first candidate starting position includes: receiving, from the first UE, the first PSCCH and the first PSSCH from the first candidate starting position in the first slot; and continuously receiving, from the first UE, a second sidelink transmission in the remaining symbols of the first slot. In some embodiments, the second sidelink transmission may be sidelink transmission #2 as described above.

In some embodiments of the present disclosure, the second sidelink transmission includes the whole or a part of the first PSCCH and the first PSSCH.

In some embodiments of the present disclosure, the second sidelink transmission includes the whole or a part of a third sidelink transmission in the case that the first UE continuously transmits the third sidelink transmission in a second slot following the first slot or the last symbol of the first slot is used for PSSCH transmission. In some embodiments, the third sidelink transmission may be sidelink transmission #3 as described above.

In some embodiments of the present disclosure, the second sidelink transmission including a second PSCCH and a second PSSCH, and the second PSCCH carries information scheduling the second PSSCH and the second PSSCH is generated based on a number of the remaining symbols of the first slot available for PSSCH transmission. In some embodiments, the second PSCCH and second PSSCH may be sidelink PSCCH #2 and PSSCH #2 as described above.

In some embodiments of the present disclosure, in the case that the first PSSCH and the second PSSCH carry different TBs, the second UE may: determine a first PSFCH resource for a first PSFCH carrying HARQ-ACK feedback for the first PSSCH and a second PSFCH resource for a second PSFCH carrying HARQ-ACK feedback for the second PSSCH based on indexes corresponding to time domain locations associated with the first PSSCH and the second PSSCH; and transmit, to the first UE, the first PSFCH on the first PSFCH resource and the second PSFCH on the second PSFCH resource. In some embodiments, the first PSFCH and second PSFCH may be PSFCH #1 and PSFCH #2 as described above. In some embodiments, the first PSFCH resource and second PSFCH resource may be PSFCH resource #1 and PSFCH resource #2 as described above.

In some embodiments of the present disclosure, in the case that the COT is initiated by the first UE from the predefined candidate starting position, the second UE may receive, from the first UE, the first PSSCH and the first PSCCH from the predefined candidate starting position in the first slot. In the case that the first UE does not contiguously transmit another sidelink transmission in a second slot following the first slot or the last symbol of the first slot is not used for PSSCH transmission, the last symbol of the first PSCCH is punctured.

In some embodiments of the present disclosure, the first PSCCH indicates whether the first UE continuously transmits another sidelink transmission in a second slot following the first slot or not. In some embodiments of the present disclosure, the first PSCCH indicates whether the last symbol of the first slot is used for PSSCH transmission or not.

In some embodiments of the present disclosure, the predefined candidate starting position is the earliest candidate starting position of the plurality of candidate starting positions.

In some embodiments of the present disclosure, receiving the first sidelink transmission in the first slot from the first candidate starting position includes: receiving, from the first UE, the first PSCCH and a part of the first PSSCH from the first candidate starting position in the first slot till a last symbol of the first slot available for PSSCH transmission; and receiving, from the first UE, the remaining part of the first PSSCH in a last slot of the COT or a last slot of a sidelink burst in which the first PSCCH and the first PSSCH are included.

In some embodiments of the present disclosure, the remaining part of the first PSSCH includes at least one DMRS symbol for decoding the first PSSCH.

In some embodiments of the present disclosure, the first PSCCH indicates a structure of the COT.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a block diagram of an exemplary apparatus 700 according to some embodiments of the present disclosure. As shown in FIG. 7, the apparatus 700 may include at least one processor 706 and at least one transceiver 702 coupled to the processor 706. The apparatus 700 may be a UE or a BS.

Although in this figure, elements such as the at least one transceiver 702 and processor 706 are described in the singular, the plural is contemplated unless a limitation to the singular is explicitly stated. In some embodiments of the present application, the transceiver 702 may be divided into two devices, such as a receiving circuitry and a transmitting circuitry. In some embodiments of the present application, the apparatus 700 may further include an input device, a memory, and/or other components.

In some embodiments of the present application, the apparatus 700 may be a UE. The transceiver 702 and the processor 706 may interact with each other so as to perform the operations with respect to the UEs described in FIGS. 1-6.

In some embodiments of the present application, the apparatus 700 may further include at least one non-transitory computer-readable medium. For example, in some embodiments of the present disclosure, the non-transitory computer-readable medium may have stored thereon computer-executable instructions to cause the processor 706 to implement the methods with respect to the UEs as described above. For example, the computer-executable instructions, when executed, cause the processor 706 interacting with transceiver 702 to perform the operations with respect to the UEs described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first user equipment (UE) for wireless communication, comprising:
at least one memory; and
at least one processor coupled with the at least one memory and configured to cause the first UE to:
generate a first sidelink transmission comprising a first physical sidelink control channel (PSCCH) and a first physical sidelink shared channel (PSSCH), wherein the first PSCCH carries information for scheduling the first PSSCH and the first PSSCH is generated according to a number of available symbols for PSSCH transmission in a first slot, and wherein the first sidelink transmission is to be started from a predefined candidate starting position of a plurality of candidate starting positions in the first slot; and
perform the first sidelink transmission in the first slot from a first candidate starting position of the plurality of candidate starting positions in response to a channel access procedure for initiating a channel occupancy time (COT) from the first candidate starting position in the first slot being successful, wherein the first candidate starting position is different from the predefined candidate starting position.

2. The first UE of claim 1, wherein the predefined candidate starting position is the last candidate starting position of the plurality of candidate starting positions.

3. The first UE of claim 2, wherein, to perform the first sidelink transmission in the first slot from the first candidate starting position, the at least one processor is configured to cause the first UE to:
transmit the first PSCCH and the first PSSCH from the first candidate starting position in the first slot; and
continuously perform a second sidelink transmission in the remaining symbols of the first slot.

4. The first UE of claim 3, wherein the second sidelink transmission comprises the whole or a part of the first PSCCH and the first PSSCH; or
wherein the second sidelink transmission comprises the whole or a part of a third sidelink transmission when the first UE continuously transmits the third sidelink transmission in a second slot following the first slot or the last symbol of the first slot is used for PSSCH transmission; or
wherein the second sidelink transmission comprising a second PSCCH and a second PSSCH, and the second PSCCH carries information scheduling the second PSSCH and the second PSSCH is generated based on a number of the remaining symbols of the first slot available for PSSCH transmission.

5. The first UE of claim 4, wherein, in response to a second transport block (TB) carried on the second PSSCH being different from a first TB carried on the first PSSCH, the at least one processor is further configured to cause the UE to:
determine a first physical sidelink feedback channel (PSFCH) resource for a first PSFCH carrying hybrid automatic repeat request acknowledgement (HARQ-ACK) feedback for the first PSSCH and a second PSFCH resource for a second PSFCH carrying HARQ-ACK feedback for the second PSSCH based on indexes corresponding to time domain locations associated with the first PSSCH and the second PSSCH; and
receive the first PSFCH on the first PSFCH resource and the second PSFCH on the second PSFCH resource.

6. The first UE of claim 2, wherein, in response to the channel access procedure for initiating the COT from the predefined candidate starting position in the first slot being successful, the at least one processor is further configured to cause the first UE to transmit the first PSSCH and the first PSCCH from the predefined candidate starting position in the first slot; and
wherein, when the first UE does not contiguously transmit another sidelink transmission in a second slot following the first slot or the last symbol of the first slot is not used for PSSCH transmission, the last symbol of the first PSSCH is punctured.

7. The first UE of claim 1, wherein the first PSCCH indicates whether the first UE continuously transmits another sidelink transmission in a second slot following the first slot or not; or
the first PSCCH indicates whether the last symbol of the first slot is used for PSSCH transmission or not.

8. The first UE of claim 1, wherein the predefined candidate starting position is the earliest candidate starting position of the plurality of candidate starting positions.

9. The first UE of claim 8, wherein, to perform the first sidelink transmission in the first slot from the first candidate starting position, the at least one processor is configured to cause the first UE to:
transmit the first PSCCH and a part of the first PSSCH from the first candidate starting position in the first slot till a last symbol of the first slot available for PSSCH transmission; and
transmit the remaining part of the first PSSCH in a last slot of the COT or a last slot of a sidelink burst in which the first PSCCH and the first PSSCH are included.

10. The first UE of claim 9, wherein the remaining part of the first PSSCH comprises at least one demodulation reference signal (DMRS) symbol for decoding the first PSSCH.

11. The first UE of claim 9, wherein the first PSCCH indicates a structure of the COT.

12. A second user equipment (UE) for wireless communication, comprising:
at least one memory; and
at least one processor coupled with the at least one memory and configured to cause the second UE to:
receive, from a first UE, a first sidelink transmission comprising a first physical sidelink control channel (PSCCH) and a first physical sidelink shared channel (PSSCH) in a first slot, wherein a channel occupancy time (COT) comprising the first sidelink transmission is initiated by the first UE from a first candidate starting position in the first slot,
wherein the first PSCCH carries information for scheduling the first PSSCH and the first PSSCH is generated according to a number of available symbols for PSSCH transmission in the first slot, and wherein the first sidelink transmission is to be started from a predefined candidate starting position of a plurality of candidate starting positions in the first slot, and the first candidate starting position is different from the predefined candidate starting position.

13. The second UE of claim 12, wherein the predefined candidate starting position is the last candidate starting position of the plurality of candidate starting positions.

14. The second UE of claim 12, wherein the predefined candidate starting position is the earliest candidate starting position of the plurality of candidate starting positions.

15. A method performed by a first user equipment (UE), the method comprising:
generating a first sidelink transmission comprising a first physical sidelink control channel (PSCCH) and a first physical sidelink shared channel (PSSCH), wherein the first PSCCH carries information for scheduling the first PSSCH and the first PSSCH is generated according to a number of available symbols for PSSCH transmission in a first slot, and wherein the first sidelink transmission is to be started from a predefined candidate starting position of a plurality of candidate starting positions in the first slot; and
performing the first sidelink transmission in the first slot from a first candidate starting position of the plurality of candidate starting positions in response to a channel access procedure for initiating a channel occupancy time (COT) from the first candidate starting position in the first slot being successful, wherein the first candidate starting position is different from the predefined candidate starting position.

16. The method of claim 15, wherein the predefined candidate starting position is the last candidate starting position of the plurality of candidate starting positions.

17. The method of claim 15, wherein the first PSCCH indicates whether the first UE continuously transmits another sidelink transmission in a second slot following the first slot or not; or
the first PSCCH indicates whether the last symbol of the first slot is used for PSSCH transmission or not.

18. The method of claim 15, wherein the predefined candidate starting position is the earliest candidate starting position of the plurality of candidate starting positions.

19. A method performed by a second user equipment (UE), the method comprising:
receiving, from a first UE, a first sidelink transmission comprising a first physical sidelink control channel (PSCCH) and a first physical sidelink shared channel (PSSCH) in a first slot, wherein a channel occupancy time (COT) comprising the first sidelink transmission is initiated by the first UE from a first candidate starting position in the first slot,
wherein the first PSCCH carries information for scheduling the first PSSCH and the first PSSCH is generated according to a number of available symbols for PSSCH transmission in the first slot, and wherein the first sidelink transmission is to be started from a predefined candidate starting position of a plurality of candidate starting positions in the first slot, and the first candidate starting position is different from the predefined candidate starting position.

20. The method of claim 19, wherein the predefined candidate starting position is the last candidate starting position of the plurality of candidate starting positions, or wherein the predefined candidate starting position is the earliest candidate starting position of the plurality of candidate starting positions.
